(19) United States
(12) Patent Application Publication
(10) Pub. No.: US 2005/0171839 A1
(43) Pub. Date: Aug. 4, 2005

(54) Communication system for business marketing including a point system to motivate users

(76) Inventor: Richard Corriere, New York, NY (US)

Correspondence Address: DICKSTEIN SHAPIRO MORIN & OSHINSKY LLP;Keith D. Nowak, 41st Floor, 1177 Avenue of the Americas, New York, NY, 10036-2714, US

(21) Appl. No.: 10/766,006

(22) Filed: Jan. 29, 2004

(51) Int. Cl. G06F 17/60

(52) U.S. Cl. 705/14

(57) ABSTRACT

A method and system for rewards-based motivation of user behavior by a sponsor. A merchant provides the consumer, via a web site or other means of communication, a customized interactive experience wherein the consumer obtains rewards in exchange for performing a behavior including but not limited to taking a quiz, supplying user information, participating in a sponsor demonstration, or otherwise learning about the goods or services of the sponsor.

### CROSS-REFERENCE TO RELATED APPLICATIONS

This application is based upon and claims priority to U.S. Provisional Application Ser. No. 60/443,221, filed Jan. 28, 2003 entitled “Communication System for Business Marketing Including a Point System to Motivate Users,” the entirety of which is incorporated herein by reference.

### BACKGROUND OF THE INVENTION

Merchants spend approximately $280 billion a year advertising goods and services. Unfortunately for these merchants, potential consumers do not view or pay attention to a very high percentage of these advertisements and therefore such advertisements are not given serious consideration. Additionally, many advertisements that consumers do view they fail to remember. Accordingly, it would be highly desirable for marketers to know that potential consumers actually view and remember if not seriously consider their advertisements. Further, it would represent an enormous financial and marketing benefit to marketers to target the consumer more cost-effectively, thus dramatically increasing the chances that potential consumers will learn about and think positively of the merchants' products or services, and maximizing the chances that the consumer will decide to buy. In other words, merchants can help to maximize return on investment by creating an incentive for the consumer to view and consider the merchant's goods and services.

It is known to give consumers an incentive in exchange for purchasing goods or services. For example, credit card use may be rewarded by frequent flyer miles, or other goods or services. That is, use of a credit card may confer a benefit or “reward” on the user above and beyond the goods or services purchased, with the assumption that consumers will be more likely to use the credit card. A drawback to this arrangement from the consumer's point of view is that the consumer must actually buy something before earning rewards. Another drawback is that these rewards may not necessarily be merchant-specific. That is, the reward is not necessarily paired with a guaranteed benefit to the particular merchant whose goods or services are purchased by the credit card.

In order to reach the target consumer efficiently and boost the likelihood of a positive buying decision, in recent years arrangements have been advanced wherein potential consumers have been given rewards or benefits in exchange for the consumers' active attention to a merchant's products or services. Although these arrangements have taken advantage of rewards-based marketing, a drawback is that the merchants are heavily dependent on the program's coordinators to find the consumers in the first place. Further, another drawback is that once potential consumers have been identified, it may be difficult for the program's coordinators to be able effectively to guarantee to the merchants that the consumers will be actively engaged in a customized product information experience with that particular merchant, rather than simply promising access to multiple merchants.

In short, there is a need for merchants to be guaranteed the active consideration of their goods or services by consumers. There is a need for reward programs that can customize product information delivery and optimize the interaction between the merchant and the consumer. In the commercial context, it would be desirable for a rewards program to measure and increase the reach, response, and conversion of potential consumers into buyers by increasing the time spent interacting with advertising from seconds to minutes. The more immersed a potential buyer is in the product information, the greater the buyer's commitment to the product and the higher the chances that a purchase will occur. The reality is that when consumers are ready to buy, the brand that they have been interacting with through rewards is their default choice. In addition, it would be of substantial value to merchants to continue to interact with and engage those consumers who have purchased their products or services, thus reaping sustained benefit from their advertising investments.

### BRIEF SUMMARY OF THE INVENTION

The present invention provides, on behalf of merchants, a points-based or rewards-based system that will motivate the behaviors of consumers including but not limited to a points-based program for potential consumers of a merchant's goods or services. The present invention enables merchants to coordinate advertising, marketing, promotions, direct mail and Internet communication and establish a customized interactive experience between merchant and consumer such that the consumer obtains rewards in exchange for contributing attention to the merchant's media, goods or services. More broadly, the present invention is directed to one party's use of an interactive forum to motivate the behavior of another party, in which the first party confers rewards in exchange for the second party's furnishing value to the first party, the metrics of such value including but not limited to attention, time, or information.

Further, the present invention enables merchants and consumers to engage in two-way, ongoing interactive communication with target audiences.

Still further, the present invention also rewards merchants with benefits in exchange for information about the consumer that will maximize the likelihood that consumers in the target market will buy that merchant's goods or services.

Still further, the present invention implements a rewards-based program that does not require the purchase of goods or services in order for points or rewards to accumulate for the consumer's benefit.

Still further, the present invention rewards consumers depending upon the attention and/or time that they convey to a given merchant's product information.

Still further, the present invention rewards consumers depending upon the information that they furnish the merchant.

Still further, the present invention rewards consumers depending upon the frequency of their interactions with the merchant.

Still further, the present invention enables merchants to accumulate consumer preference and profile information to permit highly targeted campaigns.

### BRIEF DESCRIPTION OF THE DRAWINGS

FIG. 1 shows an example of the network arrangement enabling the desired connectivity for carrying out the present invention;

FIG. 2 is a flowchart illustrating exemplary steps of the present invention; and

FIG. 3 is a sample web page screen for conducting a rewards-based interactive communication in accord with the present invention.

### DETAILED DESCRIPTION OF THE INVENTION

The present invention is directed to rewards-based programs. Rather than simply conceptualize the relationship as that between merchant and consumer, it is more broadly seen as a relationship in which one party (the “sponsor”) wishes to motivate the behavior of another party (the “user”), wherein the sponsor is willing to put in place a point system or other rewards program that will motivate that user's behavior in a way that is in the sponsor's interest. For example, in exchange for on-going interactive communication with its target audiences, a school may give rewards to potential students who interact with that school's web site in a way that increases the chances that the school will obtain a desired student body. Additionally, an employer may benefit from awarding points to employees for participating in that company's performance management programs such as performance reviews, goals and mentoring. Still further, doctors can offer reward points to patients for following a prescribed drug or rehabilitation regime, or the program can be used for recruitment and retention of service personnel such as police, fire, nurses and military.

However, as discussed in detail below, the present invention is extremely useful in structuring a rewards-based program between a user that is a merchant, or a program manager acting as the agent of the merchant, and a user that is a consumer.

Henceforth, unless specifically mentioned, the present invention will be described in the written description in the context of a relationship between a merchant and a consumer. However, it will be readily appreciated that the invention can be properly understood as broadly providing that sponsors create a rewards-based system that will motivate the behavior of users to the sponsor's benefit, regardless of whether a commercial relationship or potential commercial relationship exists. Further, it will be appreciated that the consumer may be an existing purchaser with whom the merchant wishes to maintain or deepen the relationship, or a potential consumer who has not purchased that merchant's goods or services yet. “Consumer” shall thus be used to refer to both existing and potential consumers. Additionally, the merchant may acquire the services of a program manager to establish the connectivity, or implement the rewards-based programs, or both. The program manager specializes in rewards-based user motivation. Henceforth, where reference is made to the activities of a merchant, a program manager may be in a position to carry out those activities. Likewise, where reference is made to the activities of a program manager, a merchant may be in a position to carry out those activities.

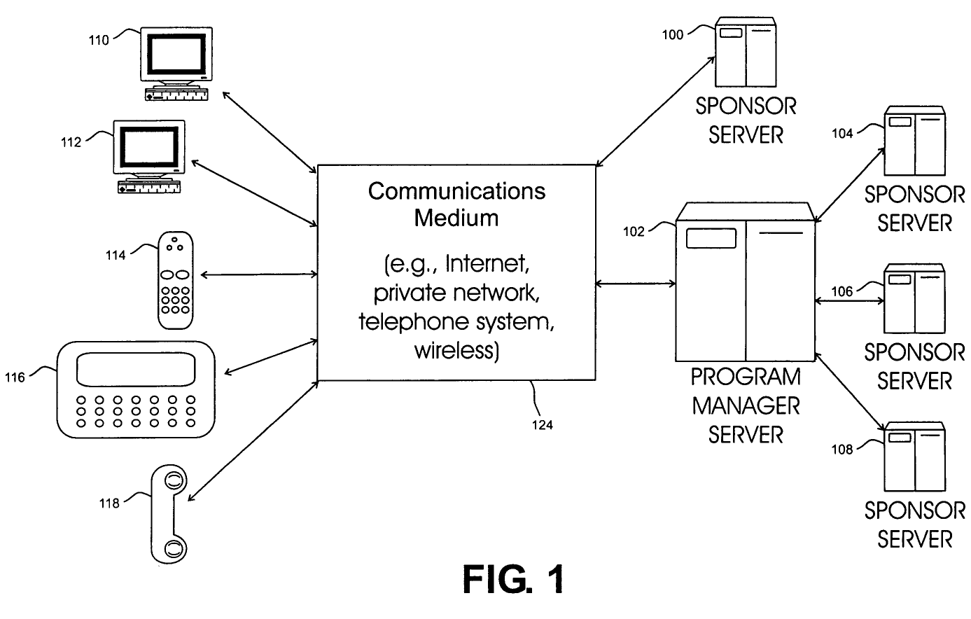

To carry out the present invention, a merchant must ensure that connectivity is established with a consumer over a communications medium 124 such as a network, as shown in FIG. 1. The present invention may be carried out over any communications medium 124. Accordingly, the present invention may be carried out over the Internet, over which merchants and consumers can communicate by any or all of the World Wide Web, email or instant messaging (IM) services, or other means of Internet communication. Further, the medium may be a dedicated or other network, including but not limited to an interactive cable or other private network, or the telephone system. Additionally, the merchant may communicate with consumers by means of wireless communications, including but not limited to communications by means of WAP (Wireless Application Protocol), SMS (Short Message Service) over a wireless cellular GSM network, or wireless Internet-based protocols such as but not limited to Mobile IP (Internet Protocol). However, the invention can also be carried out in part or in whole by voice communication as well if so desired. Individuals of skill in the art will be familiar with the range of options for establishing the means of communication between the merchant and consumer and how to implement the appropriate connectivity.

A consumer may be connected to the communications medium 124 by means of a computer 110 or computer 112, a wireless telephone 114, a mobile communications mechanism 116 such as a BlackBerry or even a suitably adapted personal digital assistant (PDA), or a telephone 118.

A sponsor server 100 connected to the communications medium 124 contains media such as web pages. A sponsor can carry out the invention by means of a server 100 under its control without the participation of a program manager server 102, which is controlled by a program manager. Alternatively, one or more sponsors can engage the services of a program manager to establish the connectivity, or implement the rewards-based programs, or both. In such a case, sponsor servers 104, 106 and 108 are connected to the program manager server 102. Here, the program manager server 102 is the primary source of communication with the user(s), and a repository of some or all of the media served to the user with respect to the rewards-based program. The sponsors control the sponsor servers 104, 106 or 108 and the program manager controls the program manager server 102.

Over the connection, the communication may take place via text, graphics, text and graphics (including a slide show), streamed audio with text and/or graphics, and streamed video with text and/or graphics.

Once a communication between a merchant and consumer has been enabled over a communications medium 124, the general structure of the motivation system must be put in place.

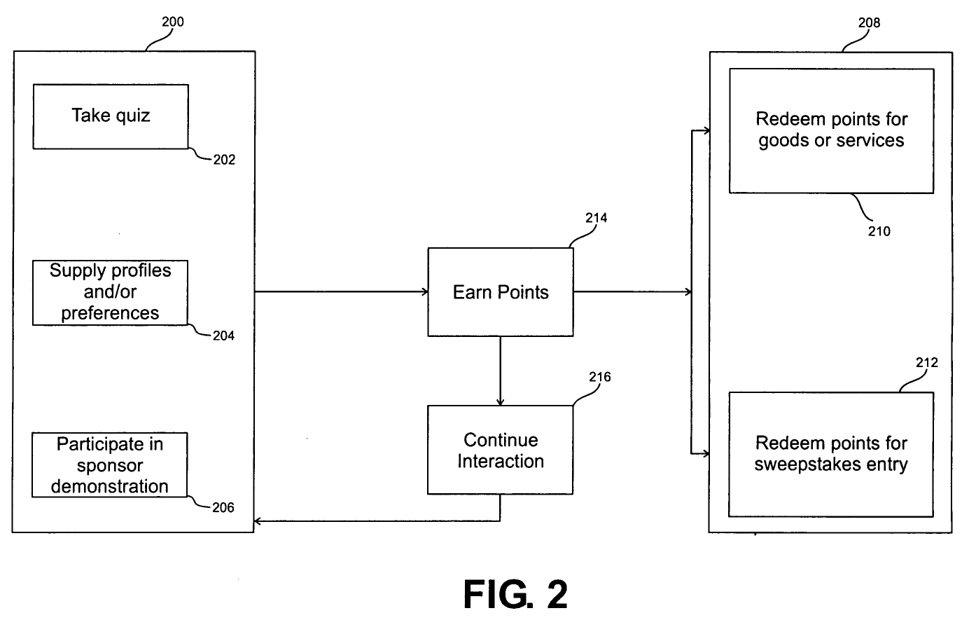

A first decision is what behavior 200 the merchant wishes to elicit, as shown in FIG. 2. Non-limiting instances of such behaviors that the merchant may reward include one or more of the following behaviors: taking a quiz 202, supplying user profiles and/or preference information 204, and participating in a sponsor demonstration 206. It will be understood that the behaviors to be elicited are not limited to those disclosed, and may include, as discussed above, following a prescribed drug regime, recruiting and retaining personnel, etc.

Another merchant decision is the mechanism for redeeming the rewards 208. Non-limiting instances of such include one or more of the following: points redeemable for goods or services 210, or points redeemable for entry in a sweepstakes 212. It will be understood that the rewards to be conferred are not limited to those disclosed, and may include anything of value to the consumer wherein the credit is measured in points or rewards. For example, some rewards may be “points only” and others “points plus credit card” in which items may be purchased by credit card at, for example, 30% to 70% below retail and others for an exceptional discount.

Broadly put, merchants identify one or more behaviors 200 they wish to elicit from consumers such as learning product information from the merchant, with non-limiting examples given in the drawings. These behaviors 200 are part of interactive experiences involving at least one communication from the merchant (which may only be serving the web page to the consumer) and at least one action in response by the user. Merchants assign a point value to the behavior 200, and consumers earn points 214 upon performing the behavior 200. The consumer may continue with the interaction 216 and earn additional points 214. Upon conditions that the merchant sets, the consumer can redeem his or her points for goods or services 210. Or, upon conditions that the merchant sets, the consumer can redeem his or her points for a sweepstakes entry 212. It will be appreciated that the points can be redeemable for something else of value, as discussed above.

In one embodiment of the present invention, consumers earn points for interacting with a merchant's information with respect to that merchant's goods or services. In this embodiment, the merchant provides a web site, or has an agent provide a web site, that includes an interactive experience that involves the consumer. For instance, a merchant may present an entertaining, easy-to-use program where the consumer earns points by learning about the merchant's product. When the consumer has earned enough points, the points can be redeemed for electronics, jewelry, getaways and other items and experiences provided on behalf of the merchant. Thus, the consumer engages in interactive and participatory learning in exchange for points. The merchant accordingly rewards the consumer for engaging in the desired behavior 200.

Additionally, the consumer might participate in an online demonstration. One such demonstration is an online slide show 206.

Alternatively, the behavior to be elicited may be a quiz 202 that the consumer plays. The subject upon which the consumer may be quizzed can relate to the merchants goods or services. Thus, an automobile maker can establish a game that tests the consumer's knowledge of cars. Some or all of the information may be related to the automobile maker's brands of cars that educates on or reinforces the positive attributes of product information related to the desired brand.

The above non-limiting examples showing rewards based on the consumer's taking a quiz 202, participating in an online demonstration 206 or otherwise learning about the merchant in exchange for rewards are examples of the mechanisms by which the sponsor permits and controls the interaction with the user. Supplying profiles and/or preferences 204 by the user is discussed below.

For the above mechanisms, hints are available using the same information display formats.

To commence the relationship, a consumer typically registers with the program manager. However, it is not necessary that the consumer be initially registered. In a preferred embodiment, points are awarded for registration. Registration can involve supplying the consumer's email address, a password, contact information such as first name, last name, zip code, Instant Messenger (IM) mechanism (e.g., AOL, MSN, Yahoo, ICQ, BlackBerry), IM name, WAP/SMS wireless info, personal information such as gender, birthday, and a product promotion/product code if any. More consumer information can be obtained once the consumer is engaged in an interactive experience with the program manager. A consumer can unsubscribe from the program. The specific rewards and drawings offered on a given web site may change at any time and are subject to availability at the time of redemption. How quickly the consumer accumulates points depends on how often the consumer participates. The more one participates, generally the more points one earns. There may be limits on eligibility. For example, once a consumer has redeemed a free reward item, the consumer will not qualify for redemption of another free reward item until he or she has redeemed a total of five (5) reward items for a combination of “points” and cash. Or, the consumer may be limited to accumulating no more than a certain amount of points per day. In addition, the point value associated with a specific reward or drawing may change from time to time. In terms of timing for rewards, the consumer can redeem all or a portion of the points accrued to his or her account at any time or at a predetermined time or set of times. Typically, the consumer's point total is automatically updated as the consumer earns additional points. The consumer's current point total may be viewed at any time by logging on to the rewards web site.

In a preferred embodiment, points are specific to a specific sponsor. That is, points are redeemable only through that sponsor, and points are not transferable to the rewards programs of other sponsors. However, a group of sponsors may elect to engage in cross-marketing of their goods or services by enabling points accrued at one sponsor to be applicable to the rewards program of one or more added sponsors.

An advantage of the present invention is a merchant's ability to establish highly targeted campaigns. This is based on the merchant's accumulation of consumer preference and profile information. As time progresses, the merchant will learn more and more of the spectrum of consumer preferences for consumers as a whole or by subgroup. Further, the merchant will learn more about an individual consumer. Based on this knowledge, merchants can deliver ever more custom-tailored product information so as to optimize the likelihood that consumer behavior will be motivated according to merchant desires.

In terms of learning consumer preferences, the merchant or program manager can also conduct custom-tailored “virtual focus groups” for a given product. Participants in these programs will be awarded points. Alternatively, the merchant or program manager can aggregate and analyze the behaviors of multiple participants matching certain criteria by appropriate methods or data mining.

Although technical issues such as connectivity will be appreciated by one of skill in the art, it is preferable to allow participation only if the consumer allows “cookies” on his or her browser. While it is possible to set up accounts for a family, it is preferable that each individual establish his/her own account. If the consumer forgets the password, he or she may simply complete the ID and password help form and the information will be sent via e-mail.

There may be rewards-based marketing communications for companies involving general information, surveys, research and/or polls.

Another embodiment of the present invention provides for a partnership between a merchant and the program manager. According to this embodiment, the program manager displays on its web site, or at the web site of an agent, the advertisements, product information or marketing materials of one or more merchants. In this embodiment, the merchant pays a percentage of its media fees in barter with its own products. In addition, merchants provide goods to the program manager at discounts, which are then sold to game participants for an “agreed upon mark up” which is divided between the program manager and the merchant. One approach is to offer consumers rewards based on media exposure as determined by a suitable metric.

In another embodiment of the present invention, sweepstakes can be used to encourage a consumer's interaction with or viewing of the merchant's product information. Sweepstakes are events wherein multiple consumers are entered and a subset of these consumers gets a prize or other benefit. Although the invention may be carried out by providing that the consumer is rewarded for his or her active attention with points, it is also possible to carry out the invention by rewarding the consumer with entry into a sweepstakes 212. Additionally, the consumer can be rewarded with a combination of points and sweepstakes, and/or other benefits. For example, a consumer may “pay” 5000 points per ticket in order to obtain one or more tickets in a drawing where the grand prize is a featured brand of the car manufacturer, or 1000 points for a weekly drawing in which the prize is a computer.

It is important to understand that the invention is concerned with rewarding the consumer for his or her active attention in order to motivate user behavior. With this in mind, it is not necessary for the consumer to purchase the goods or services in question in order to qualify for rewards. More broadly, the consumer can be rewarded for providing information, time, or another behavior. Accordingly, unlike purchase-based rewards programs, the rewards programs disclosed by the present invention are more general in application. No purchase is necessarily required. Nonetheless, the merchant may get precisely what it wants: committed consumer “mind share” and the heightened prospect that the consumer will buy in the future.

In another embodiment of the invention, consumers can be rewarded in exchange for the behavior 200 of supplying personal information and/or preferences 204. Merchants are ever aware that a particular population demographic may contain the target consumer, and spend countless dollars trying to refine the profile of this desired demographic. In the rewards-based programs in accordance with this invention, merchants can more easily and cost-effectively gain a great deal of information on the potential consumer in order to refine the demographic than by conventional methods. The type of personal information that merchants can award points for is limited only by the needs and imagination of the merchant. Clearly, the merchant would benefit from knowing the consumer's location, disposable income, and buying habits. Beyond this, however, the rewards-based programs described herein are able to get even more granular information.

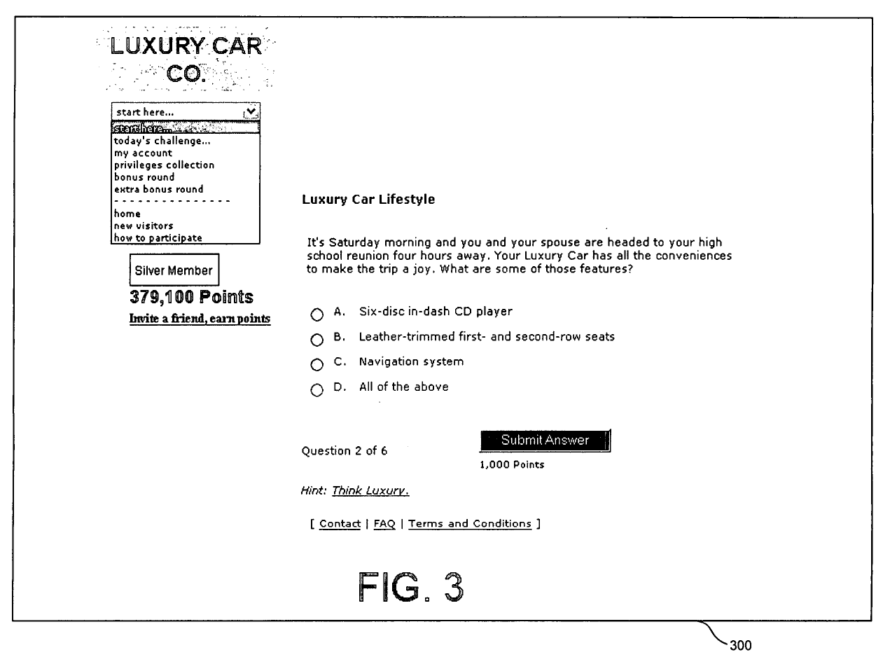

A sample web page in accord with the present invention is shown in FIG. 3, showing a sample quiz 202.

For example, the information desired may be information regarding the commercial profile of the consumer's children or other family members. Also, combining the acquisition of personal information with advertising, the merchant may provide the consumer with a “minicommercial.” The minicommercial, as demonstrated in FIG. 3, may be in the form of lifestyle questions and answers. For example, a car manufacturer in promoting a certain brand of car might ask, “You're picking up your 13-year old and her friends from band practice. How many seats will you need in the car?” Upon obtaining the answer, the car manufacturer may be in a position to reinforce the benefits of buying the particular brand. Also, the car manufacturer is gaining valuable information from the consumer that could influence the consumer's buying decision. As a further example, a car manufacturer may provide a “VIP Test Drive” to gauge consumer preferences. Also, a merchant in the travel industry might ask, “Which of the following sports vacations would appeal to you if offered as a reward?” The options include golf, tennis, beach, boating/sailing, exercise/yoga, horseback riding, ski vacation, other, all of the above, and/or none of the above. Additionally, the consumer can be rewarded for referring other individuals to the merchant.

In another embodiment of the invention, the rewards-based programs are designed to develop a standing pool of rewards-based research subjects that researchers can acquire information from on an ongoing basis. These subjects are preferably contacted by wireless, IM or email. To put this in context, most marketing research programs continually start their research with groups of people that are typically characterized as “randomly selected.” In fact, these “randomly selected” groups are a subset of the population and not a true random sample. In addition, marketing researchers know relatively little profile information about the typical research participant. The program manager can build a pool of ongoing research participants about whom it has in-depth profile information. The pool will be rewarded for their participation. Unlike with most research groups, the program manager will be able to make the link between research responses and buying behavior as the consumers can use a program-manager-sponsored credit card, where buying information is conveyed to the program manager.

In another embodiment of the invention, emails (or other forms of communication) may be sent a targeted set of consumers. These integrated emails will be sculpted for the specific targeted consumers, and be an effective form of one-to-one marketing unavailable in the conventional non-rewards-based advertising paradigm, where the advertiser does not know enough information to create a successful integrated email.

Although the present invention has been described in relation to particular embodiments thereof, many other variations and modifications and other uses will become apparent to those skilled in the art. It is preferred, therefore, that the present invention be limited not by the specific disclosure herein, but only the appended claims.

1. A method for a sponsor to motivate a user based on a rewards program, the sponsor and user communicating over a communications medium, the method comprising:
awarding points to the user in response to a behavior by the user, the behavior excluding a purchase of goods or services by the user; and
redeeming the points of the user in exchange for rewards, the points being exclusively redeemable through the sponsor.

2. The method according to claim 1, wherein the communications medium includes the Internet.

3. The method according to claim 1, wherein the communications medium includes a private network.

4. The method according to claim 1, wherein the communications medium includes a telephone system.

5. The method according to claim 1, wherein the communications medium includes wireless communications.

6. The method according to claim 1, wherein the behavior comprises supplying user information.

7. The method according to claim 1, wherein the behavior comprises the user's clicking on a web page provided by the sponsor.

8. The method according to claim 1, further comprising:
awarding points as a factor of the frequency of consumer communications with the sponsor.

9. The method according to claim 1, further comprising:
maintaining information based on communications with multiple users.

10. The method according to claim 9, further comprising:
analyzing the information.

11. The method according to claim 1, further comprising:
maintaining information based on multiple communications with one user.

12. The method according to claim 11, further comprising:
analyzing the information.

13. The method according to claim 1, further comprising:
sending an email to the user based on information obtained from the user.

14. The method according to claim 1, wherein the redeeming step further comprises redeeming points for goods or services.

15. The method according to claim 1, wherein the redeeming step further comprises redeeming points for entry in a sweepstakes.

16. The method according to claim 1, wherein the rewards comprise goods or services supplied, in part or in whole, in barter.

17. The method according to claim 1, wherein the sponsor is a merchant.

18. The method according to claim 1, wherein the sponsor engages the services of a program manager as an agent of a merchant.

19. A system for implementing a rewards-based program, the system comprising:
a communications medium;
at least one user computer used by a user; and
at least one rewards program server, the at least one rewards program server programmed to award points to the user in response to a behavior by the user, the behavior excluding a purchase of goods or services by the user, the rewards program server further programmed to redeem the points of the user in exchange for rewards, the points being exclusively redeemable through the sponsor.

20. The system as recited in claim 19, wherein the at least one rewards program server hosts a plurality of rewards-based programs for a plurality of sponsors
